(19) United States
(12) Patent Application Publication
(10) Pub. No.: US 2004/0049747 A1
(43) Pub. Date: Mar. 11, 2004

(54) Verification apparatus

(75) Inventors: Terutoshi Yamasaki, Tokyo (JP); Masaaki Harada, Tokyo (JP); Keiko Natsume, Tokyo (JP)

Correspondence Address: MCDERMOTT, WILL & EMERY, 600 13th Street, N.W., WASHINGTON, DC, 20005-3096, US

(73) Assignee: RENESAS TECHNOLOGY CORP.

(21) Appl. No.: 10/435,045

(22) Filed: May 12, 2003

(30) Foreign Application Priority Data
Sep. 11, 2002 (JP) 2002-265251

(51) Int. Cl. G06F 17/50

(52) U.S. Cl. 716/4; 716/12; 716/5

(57) ABSTRACT

Cross reference information is generated when comparing between a logic circuit and a layout in order to facilitate retrieval of optimum corresponding information of logic circuit and layout. A design verification apparatus includes a storage unit which stores logic circuit data and layout data on its layout pattern; an element recognition unit which recognizes the connection relation of elements, and a comparative verification unit. The comparative verification unit compares and verifies the correspondence between the connection relation of logic circuit and connection relation of layout based on the logic circuit data to merge elements of the logic circuit, and compares and verifies the correspondence of the connection relation of the merged elements. Further, the apparatus generates a cross reference information file specifying the corresponding relation of the elements and their wiring in first and second function units depending on the connection relation of the logic circuit.

### FIELD OF THE INVENTION

The present invention relates to an apparatus for verifying operations of a logic circuit useful for computer-aided design of semiconductor integrated circuits. More particular, the invention relates to a semiconductor design verification apparatus for extracting information of parasitic elements latently existing in pattern wiring by using mask layout pattern data corresponding to a logic circuit, and verifying the operations of the logic circuit in consideration of the extracted parasitic element information.

### DESCRIPTION OF THE BACKGROUND ART

FIGS. 21 to 23 are block diagrams showing a configuration of a conventional semiconductor design verification apparatus for back annotation. The back annotation refers to a process of reflecting locations or actual pin names determined in a design for mounting, or information of added or deleted parts in a logic circuit diagram. When a parts layout is completed, delay of the circuit can be estimated by using an actual wiring length. Accordingly, when the delay information extracted from the layout is reflected in gate level simulation, an accurate operation speed of the circuit can be judged. The back annotation is necessary for manufacturing a semiconductor device which satisfies a desired speed specification.

Referring first to FIG. 21, a conventional semiconductor design verification apparatus includes a database 1 storing logic and circuit design data, a database 2 storing mask layout pattern data, a layout-versus-schematic (LVS) comparator 3, a net list generator 9, net list(s) with layout parasitic elements 10, and analyzer 11. LVS comparator 3 compares and verifies a corresponding relation between the connection relation of wiring and devices recognized based on layout data 2, and the connection relation recognized based on logic circuit data 1. This is called a layout-versus-schematic (LVS) comparison. Net list generator 9 extracts element information parasitizing the layout based on the comparison result, and generates one or more net lists with layout parasitic elements 10. Analyzer 11, using the net lists with layout parasitic elements 10, verifies and analyzes the operation of the logic circuit taking the element information parasitizing the layout into account.

FIG. 22 is a block diagram showing a configuration of a semiconductor design verification apparatus for path selection type back annotation. The path selection type back annotation is executed prior to completion of layout design or the like. It is one type of back annotations, which can incorporate considerations only of the layout parasitic element information corresponding to portion(s) of the circuit necessary for simulation, based on the circuit simulation result which do not incorporate considerations of the parasitic element information extracted from the layout. Accordingly, this semiconductor design verification apparatus further includes pre-layout simulation unit 14 for executing operation verification of circuit by using logic circuit data 1, which do not consider the parasitic element information, and node list 15 describing its result. Further, the semiconductor design verification apparatus includes path selection type net list generator 18, path selection type net list 19, and path selection type analyzer 20, instead of net list generator 9, net lists with layout parasitic elements 10, and analyzer 11 shown in FIG. 21.

FIG. 23 is a block diagram showing a configuration of a semiconductor design verification apparatus for power supply/GND line back annotation. In the power supply/GND line back annotation, only the layout parasitic element information of the power supply/GND line is considered, and the net lists of logic circuit base is used as internal circuit information. This semiconductor design verification apparatus includes power supply/GND net list generator 29, net lists with power supply/GND layout parasitic elements 26, and power supply/GND analyzer 27, instead of net list generator 9, net list with layout parasitic elements 10, and analyzer 11 shown in FIG. 21.

In the conventional semiconductor design verification apparatuses, however, back annotation could not be always done appropriately in spite of pretreatment for back annotation. For example, if the conventional apparatus recognizes that the logic circuit and the layout are logically equivalent as a result of LVS comparison, or if devices included in the merged device group and the numbers thereof do not have one-to-one relationships between the logic circuit and the layout, the device or wiring on the layout may sometimes fail to include the information of a device name or a wiring name on the corresponding logic circuit. Accordingly, in the back annotation using the net lists with parasitic element information of layout base (FIG. 22), the waveform input/waveform display points retrieved from the logic circuit diagram, or the block input and output points could not be designated, and it took much time to search the corresponding point on the layout data. Further, there is a risk of designating a wrong corresponding point.

Referring now to FIG. 24, this problem is explained more specifically. FIG. 24 is a logic circuit diagram showing an example of improper back annotation. Suppose to analyze mark points indicated by “x” in FIG. 24 due to timing errors or the like. For example, at two points indicated by arrows, names “XIBUF|XIW<2>|XI22|MI40:GATE” and “XIBUF|XIW<2>|XI22|MI40: DRAIN” are searched from the logic circuit diagram. On the other hand, in the net list with parasitic element information extracted from the layout, element information may be sometimes output in such wiring names as “NODE111:GATE ”and “NODE111:DRAIN”. According to this result, it can not be determined which node is indicated by “NODE111”, or which is the corresponding “GATE” among the plurality of “GATE”s. That is, the corresponding point on the net list cannot be searched.

Further, in the power supply/GND line back annotation (FIG. 23), mismatching may occur in a linkage of an internal circuit net list based on the logic circuit and the power supply/GND net list with parasitic element information based on the layout. It may involve possibility of overlooking a risky point of occurrence of voltage drop or electromigration.

### SUMMARY OF THE INVENTION

It is hence an object of the invention to facilitate search and use of information about optimum correspondence between logic circuit and layout by generating cross reference information including swap information when comparing between the logic circuit and the layout (LVS comparison).

The design verification apparatus of the invention includes a storage unit storing logic circuit data about elements in a logic circuit and wiring among the elements, and layout data about layout pattern of the logic circuit, an element recognition unit for recognizing the connection relation of the elements based on the layout data, and a comparative verification unit for comparing and verifying the correspondence between the connection relation of the logic circuit based on the logic circuit data, and the connection relation of the layout recognized by the element recognition unit. The comparative verification unit merges plural elements in the logic circuit as a first function unit based on the logic circuit data, merges plural elements in the logic circuit as a second function unit based on the connection relation recognized by the element recognition unit, and compares and verifies the correspondence of a first connection relation of plural merged elements in the first function unit and a second connection relation of plural merged elements in the second function unit. The design verification apparatus further includes, depending on the connection relation of the logic circuit, a cross reference information filing unit for generating cross reference information specifying the corresponding relation of the plural elements in the first function unit and their wiring and the plural elements in the second function unit and their wiring.

In such design verification apparatus, the cross reference information filing unit generates cross reference information specifying the corresponding relation of plural elements in the logic circuit and their wiring, and plural elements in the layout pattern and their wiring, and therefore identifies the correspondence of the logic circuit and layout in all elements including elements and intermediate wiring. Therefore, at the time of back annotation for verifying and analyzing the operation of the logic circuit considering the element information parasitizing the layout, by referring to these pieces of cross reference information, more specific analysis is possible, and only a specified path can be analyzed. That is, correspondence of wiring name and device name of logic circuit and layout can be recognized easily, and the wiring name and device name can be designated by the name on the logic circuit diagram. As a result, the recognition efficiency of corresponding relation can be enhanced in back annotation, and recognition errors can be reduced. For example, the cross reference information filing unit generates cross reference information of logic circuit in which parallel connection/serial connection/parallel connection and serial connection coexist. Further, the cross reference information filing unit generates cross reference information showing that the element group judged to be logically equivalent can be replaced.

### BRIEF DESCRIPTION OF THE DRAWINGS

This and other objects and features of the present invention will become clear from the subsequent description of a preferred embodiment thereof made with reference to the accompanying drawings, in which like parts are designated by like reference numerals and in which:

FIG. 1 is a block diagram showing a configuration of a design verification apparatus in embodiment 1;

FIG. 2 is a diagram showing a more specific example of logic circuit data, layout data and LVS comparator;

FIG. 3 is a diagram showing an example of logic circuit and layout composed of plural devices by parallel connection;

FIG. 4 is a diagram showing a cross reference information file output by a parallel device cross reference information filing unit;

FIG. 5 is a diagram showing an example of logic circuit and layout composed of plural devices by serial connection;

FIG. 6 is a diagram showing a cross reference information file output by a serial device cross reference information filing unit;

FIG. 7 is a diagram showing an example of logic circuit and layout composed of plural devices by parallel connection and serial connection;

FIG. 8 is a diagram showing a cross reference information file output by a parallel-serial device cross reference information filing unit;

FIG. 9 is a diagram showing an example of logic circuit and layout composed of plural devices by serial connection;

FIG. 10 is a diagram showing a cross reference information file output by a logically equivalent device cross reference information filing unit;

FIG. 11 is a block diagram showing a configuration of a design verification apparatus in embodiment 2;

FIG. 12A is a diagram showing logic circuit and layout;

FIG. 12B is a diagram showing a cross reference information file created by a logically equivalent device cross reference information filing unit from the logic circuit and layout in FIG. 12A;

FIG. 12C is a diagram of an information retrieval result based on transistor gate element;

FIG. 13 is a block diagram showing a configuration of a design verification apparatus in embodiment 3;

FIG. 14A is a diagram showing logic circuit and layout;

FIG. 14B is a diagram showing a cross reference information file created by a logically equivalent device cross reference information filing unit from the logic circuit and layout in FIG. 14A;

FIG. 14C is a diagram of an information retrieval result based on transistor source/drain element;

FIG. 15 is a block diagram showing a configuration of a design verification apparatus in embodiment 4;

FIG. 16A is a diagram showing logic circuit and layout;

FIG. 16B is a diagram of a cross reference information file created by a parallel-serial device cross reference information filing unit based on the logic circuit and layout in FIG. 16A;

FIG. 16C is examples of active node list and inactive node list;

FIG. 16D is examples of converted active node list and converted inactive node list;

FIG. 17 is a block diagram showing a configuration of a design verification apparatus in embodiment 5;

FIG. 18A is a diagram showing logic circuit and layout;

FIG. 18B is a diagram of a cross reference information file created by a parallel-serial device cross reference information filing unit based on the logic circuit and layout in FIG. 18A;

FIG. 18C is examples of active node list and inactive node list;

FIG. 18D is a diagram showing retrieval results based on logic circuit;

FIG. 19 is a block diagram showing a configuration of a design verification apparatus in embodiment 6;

FIG. 20A is a diagram showing logic circuit and layout;

FIG. 20B is a diagram of a cross reference information file created by a parallel device cross reference information filing unit based on the logic circuit and layout in FIG. 20A;

FIG. 20C is a diagram showing retrieval results by an information retrieval unit;

FIG. 21 is a block diagram showing a configuration of a conventional semiconductor verification apparatus;

FIG. 22 is a block diagram showing a configuration of a semiconductor verification apparatus for path selection type back annotation;

FIG. 23 is a block diagram showing a configuration of a semiconductor verification apparatus for power supply/GND line back annotation; and

FIG. 24 is a logic circuit showing an unsuccessful example of back annotation.

### DETAILED DESCRIPTION OF THE PREFERRED EMBODIMENTS

Preferred embodiments of the invention are described below with reference to the accompanying drawings. In the specification, a semiconductor design verification apparatus which verifies operations of a logic circuit is explained. More specifically, the apparatus extracts information of parasitic elements latently existing in pattern wiring by using mask layout pattern data corresponding to a logic circuit, and verifies the operations of the logic circuit in consideration of the extracted parasitic element information. In the following preferred embodiments, the semiconductor design verification apparatus is referred to as a design verification apparatus. In the drawings, same or similar constituent or functional elements are identified with same reference numerals.

(Embodiment 1)

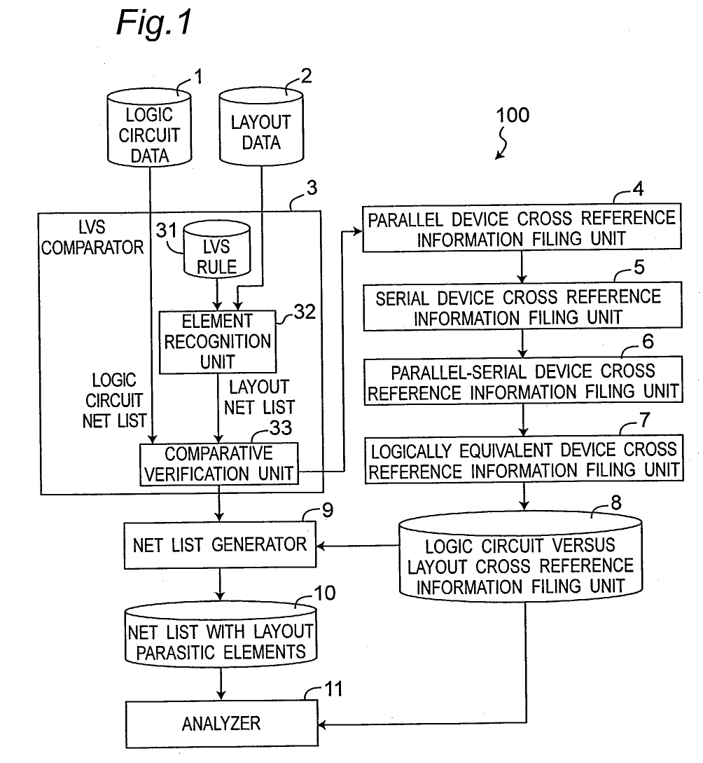

FIG. 1 is a block diagram showing a configuration of design verification apparatus 100 in embodiment 1. Design verification apparatus 100 includes a database 1 which stores logic and circuit design data, a database 2 which stores mask layout pattern data, an LVS comparator 3, cross reference information filing units 4 to 7 of parallel device, serial device, parallel-serial device, and logically equivalent device, a cross reference information file 8 which relates to logic circuit versus layout, a net list generator 9, a net list with layout parasitic elements 10, and an analyzer 11. In the specification, the information included in database 1 is called “logic circuit data 1.” The information included in the database 2 is called “layout data 2.” Databases 1 and 2 are shown separately for the convenience of explanation, but they may be provided in a same storage device.

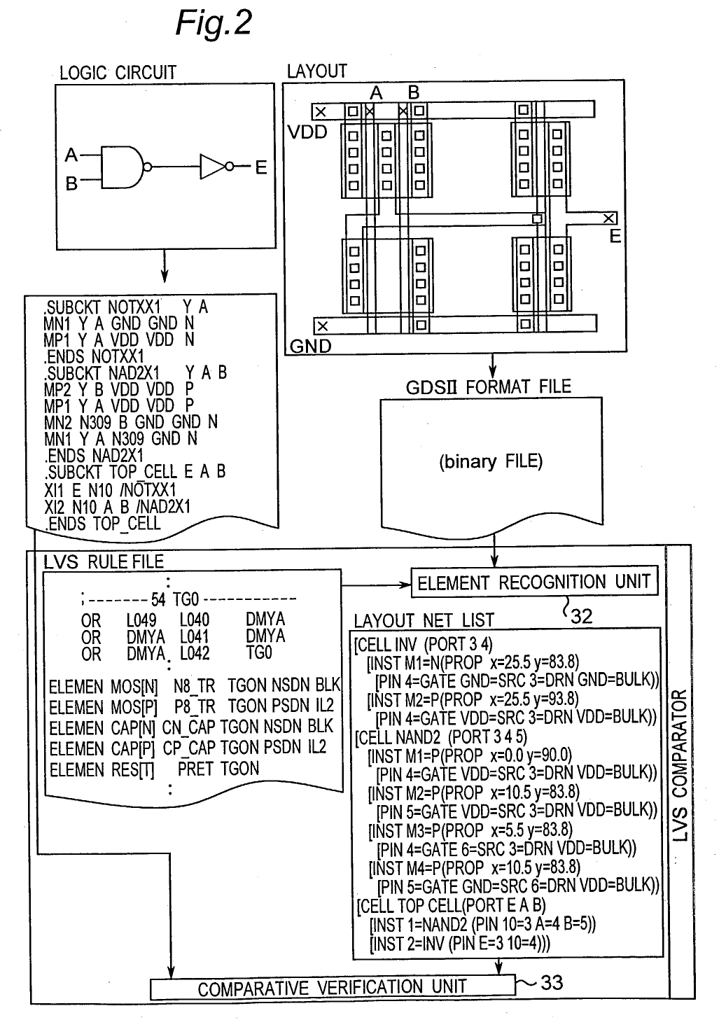

Functions and operations of each element are explained. Logic circuit data 1 is generated based on elements of the logic circuit and connection among the elements. In the specification, for example, logic circuit data 1 is explained as the logic circuit net list data. Layout data 2 is of the whole layout of connection relation and positions of power supply potential and grounding potential expressed by a specified format. Logic circuit data 1 and layout data 2 are described below with reference to FIG. 2.

LVS comparator 3 compares and verifies a corresponding relation of the connection relation of wiring and device recognized based on layout data 2, and the connection relation recognized based on logic circuit data 1. It is intended to verify if the created data has the same connection relation as the logic circuit or not. This function is called the layout-versus-schematic (LVS) function. LVS comparator 3 includes database 31 which stores a LVS rule defining terms when describing the layout structure (hereinafter called LVS rule 31), element recognition unit 32, and comparative verification unit 33. Element recognition unit 32 recognizes the wiring and device indicated by layout data 2 based on LVS rule 31 and layout data 2. Further, element recognition unit 32 issues a layout net list describing the information of the wiring and device in the recognized layout. Comparative verification unit 33 compares the connection relation of the wiring and device and verifies the corresponding relation, based on the logic and circuit design data of logic circuit data 1 and the layout net list issued from element recognition unit 32. The comparison and verification are executed by using the known LVS.

In succession, parallel device cross reference information filing unit 4 of design verification apparatus 100 files the cross reference information of the parallel merged device group merged by LVS comparator 3 by the original standard. The cross reference information specifies the corresponding relation of logic circuit and layout generated by cross reference information filing units 4 to 7. The detail is described later. Other cross reference information filing units 5 and 6, similarly, file the cross reference information of serial merged device group, and parallel and serial composite merged device group, merged by LVS comparator 3 by the original standard. On the other hand, logically equivalent device cross reference information filing unit 7 files the cross reference information including the swap information of the device group recognized to be logically equivalent by LVS comparator 3.

Net list generator 9 extracts information on element(s) parasitizing the layout based on the comparison result by LVS comparator 3 and cross reference information file 8, and generates net list with layout parasitic element information 10. Herein, the wording “element(s) parasitizing” means that circuit element(s) latently existing in the layout wiring, such as capacitance disposed without consciousness. The generated net list with layout parasitic elements 10 is stored in a specified storage medium such as hard disk. Analyzer 11 verifies and analyzes the operation of the logic circuit in consideration of the element information parasitizing the layout by using cross reference information file 8 and net list with layout parasitic elements 10.

FIG. 2 is a diagram showing a more specific example of logic circuit data 1, layout data 2, and LVS comparator 3. The circuit composed of NAND circuit and NOT circuit shown as “logic circuit” is expressed as “logic circuit net list” as shown in the diagram. The logic circuit net list is an ASCII format list describing the information of wiring and device in the logic circuit, and CDL format and SPICE format are known. Logic circuit data 1 (FIG. 1) is such logic circuit net list.

On the other hand, a specific layout corresponding to the logic circuit shown as “layout” is expressed as mask layout pattern. The mask layout pattern is of all information about layout such as whole layout of position and connection relation expressed in a specified format, for example, binary GDSII format (because of binary format, specific example of data is not shown, but its content can be interpreted by LVS comparator 3). The layout data (FIG. 1) is such mask layout pattern data. “LVS rule file” is an example of content of the data file defining the terms when describing the layout structure stored in the LVS rule 31 (FIG. 1).

Element recognition unit 32 generates a layout net list based on the mask layout pattern of the GDSII format file and the LVS rule of LVS rule file. For example, the lower four lines of [CELL INV{PORT 3 4}] describe the inverter elements of the logic circuit, and the lower eight lines of [CELL NAND2{PORT 3 4 5}] describe the NAND elements of the logic circuit. The lower two lines of [CELL TOP_CELL{PORT E A B}] show the input and output relation of the entire logic circuit.

Comparative verification unit 33 compares the connection relation of wiring and device by using the LVS and verifies the corresponding relation, based on the layout net list and logic circuit net list generated by element recognition unit 32.

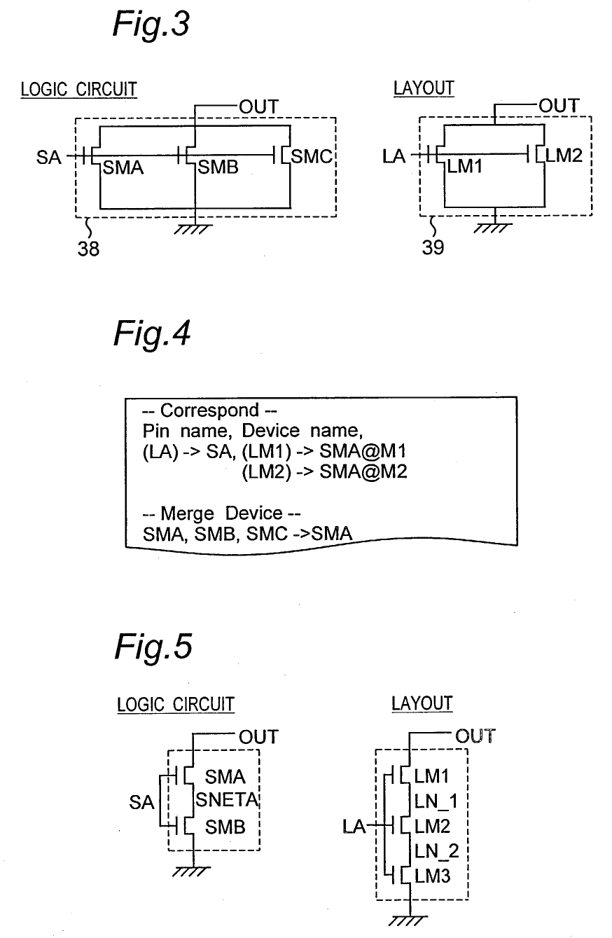

Referring now to FIGS. 3 to 12, the whole operation of filing units 4 to 7 (FIG. 1) are explained. The explanation begins with parallel device cross reference information filing unit 4 (FIG. 1).

Filing unit 4 (FIG. 1) receives the merged logic circuit net list and layout net list generated at the time of LVS comparison from comparative verification unit 33, and generates cross reference information. The cross reference information specifies the corresponding relation of the device and wiring of logic circuit net list and device and wiring of layout net list, when plural devices are regarded as one function unit, that is, when plural devices are handled as a merged one. Since filing unit 4 (FIG. 1) generates the cross reference information of parallel connected devices, cross reference information file cannot be generated when the connection is other than parallel connection, for example, in the case of serial connection. In such a case, the received net list or the like is directly sent to subsequent filing unit 5 (FIG. 1). In the following explanation, any one of filing units 4 to 7 is supposed to receive a merged logic circuit net list and layout net list from comparative verification unit 33.

FIG. 3 is a diagram showing an example of logic circuit and layout composed of plural devices by parallel connection. The logic circuit includes three devices SMA, SMB, SMC, of which input is SA and output is OUT. LVS comparator 3 merges these three devices SMA, SMB, SMC at the time of LVS comparative verification in comparative verification unit 33 (FIG. 1), and simplifies ultimately to handle the logic circuit net list. In this example, LVS comparator 3 handles the logic circuit net list as one function box 38, of which input is SA and output is OUT. When judging whether the given logic circuit or layout is serial connection or parallel connection, it can be judged, for example, based on the route from OUT to GND. That is, when the devices are disposed consecutively from OUT to GND, it is judged to be serial connection, and if plural routes are present, it is judged to be parallel connection. Filing unit 4 (FIG. 1) receives the information in box 38 expressed as follows.

{INST ParaChain#1=N||3 {PIN GND=SD#0 OUT=SD#1 SA=G#0 GND=BULK}}

As the information expressing box 38, filing unit 4 (FIG. 1) also holds the following.

ParaChain#1 {inst SMA=N} {inst SMB=N} {inst SMC=N}

As for the layout, similarly, LVS comparator 3 simplifies ultimately and handles the layout net list. In this example, LVS comparator 3 merges devices LM1 and LM2 at the time of LVS comparative verification in comparative verification unit 33 (FIG. 1), and handles the layout net list as one function box 39, of which input is LA and output is OUT. Thus, by merging into one function box, correspondence of logic circuit and layout is attained. Box 39 is expressed as follows, and filing unit 4 (FIG. 1) receives this information.

{INST ParaChain#8=N||2 {PIN GND=SD#0 OUT=SD#1 LA=G#0 GND=BULK}}

As the information expressing box 39, filing unit 4 (FIG. 1) also holds the following.

ParaChain#8{inst LM1=N{prop n=N, x=5.500, y=93.800}}

{inst LM2=N {prop n=N, x=9.900, y=93.800}}

Filing unit 4 (FIG. 1) processes as follows based on the information identifying box 38 and box 39 mentioned above. That is, by comparison of peripheral connection relation, the input SA of the logic circuit net is judged to correspond to the input LA of the layout. At this time, ParaChain#1 of the logic circuit and ParaChain#8 of the layout are matched in all pins, and hence it is judged as ParaChain#1==ParaChain#8 (coincidence). At this point, ParaChain#1==ParaChain#8 and SA==LA are obtained.

Consequently, filing unit 4 (FIG. 1) judges that the number of parallel devices corresponding to the logic circuit and layout is plurality to plurality (in this example, 3 to 2) based on these pieces of information and each net list. Accordingly, filing unit 4 (FIG. 1) issues one device name of the logic circuit as a representative name. Any device name may be used arbitrarily.

FIG. 4 is a diagram showing a cross reference information file issued by filing unit 4 (FIG. 1). In the column of “-Merge Device-” in FIG. 4, three device names (SMA, SMB, SMC) and representative name (SMA) of the logic circuit are shown. Once the representative name is determined, the name is added to the device in the layout. The name is given in a format of “representative name@xx”. Herein, “xx” is, in the case of MOS device, a symbol “M” followed by a numeral. In the examples in FIG. 3 and FIG. 4, “SMA@M1” and “SMA@M2” are given. In the column of “-Correspond-” in FIG. 4, it is understood that “SMA@M1” corresponds to “LM1” of the layout, and “SMA@M2” to “LM2”. In this manner, filing unit 4 (FIG. 1) generates a correspondence table between the logic circuit and layout.

The cross reference information generated by filing unit 4 (FIG. 1) is stored in cross reference information file 8 through the remaining filing units 5 to 7, and is used in the later process in net list generator 9 or analyzer 11. For example, in net list generator 9 or analyzer 11, suppose a device name of the layout corresponding to the device SMB of the logic circuit shown in FIG. 3 is needed. Net list generator 9 picks up the information that the “SMB” is merged in the “SMA” from -“Merge Device”- and the following in cross reference information file shown in FIG. 4. Next, referring to “Device name” after -“Correspond”-, it further picks up the information that it corresponds to two layout devices “LM1” and “LM2”. Thus, device names “LM1” and “LM2” of the layout corresponding to the “SMB” are obtained.

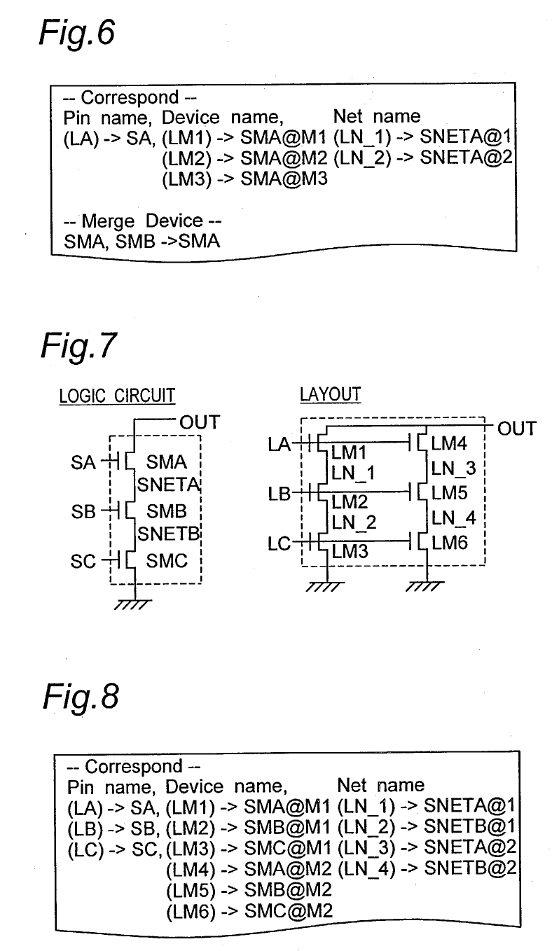

Referring now to FIG. 5 and FIG. 6, the operation of serial device cross reference information filing unit 5 (FIG. 1) is explained. FIG. 5 is a diagram showing an example of logic circuit and layout composed of plural devices by serial connection. The logic circuit includes two device names SMA and SMB, of which input is SA and output is OUT, and an intermediate wiring SNETA. LVS comparator 3 merges these two devices SMA and SMB at the time of LVS comparative verification in comparative verification unit 33 (FIG. 1), and handles the logic circuit net list as one function box enclosed by dotted line of which input is SA and output is OUT. Filing unit 5 (FIG. 1) receives the information of this box expressed as follows.

{INST SeriChain#1=N--2 {PIN GND=SD#0 OUT=SD#1 SA=G#0 GND=BULK}

As the information expressing the function box, filing unit 4 (FIG. 1) also holds the following.

SeriChain#1 {inst SMB=N} {inst SMA=N}

As for the layout, similarly, LVS comparator 3 merges the devices LM1 to LM3 at the time of LVS comparative verification by comparative verification unit 33 (FIG. 1), and handles the layout net list as one function box enclosed by dotted line of which input is LA and output is OUT. Filing unit 5 (FIG. 1) receives the information of this box expressed as follows.

{INST SeriChain#8=N--3 {PIN GND=SD#0 OUT=SD#1 LA=G#0 GND=BULK}}

As the information expressing the box, filing unit 4 (FIG. 1) also holds the following.

SeriChain#8 {inst LM3=N {prop n=N, x=5.500, y=93.800}}

{inst LM2=N {prop n=N, x=7.900, y=93.800}}

{inst LM 1=N {prop n=N, x=9.900, y=93.800}}

Filing unit 5 (FIG. 1) processes as follows based on the information identifying each box mentioned above. That is, by comparison of peripheral connection relation, the input SA of the logic circuit net is judged to correspond to the input LA of the layout. At this time, SeriChain#1 of the logic circuit and SeriChain#8 of the layout are matched in all pins, and hence it is judged as SeriChain#1==SeriChain#8 (coincidence). At this point, SeriChain#1==SeriChain#8 and SA==LA are obtained.

Filing unit 5 (FIG. 1) judges that the number of serial devices corresponding to the logic circuit and layout is plurality to plurality (in this example, 2 to 3) based on these pieces of information and each net list. Accordingly, filing unit 5 (FIG. 1) issues one device name of the logic circuit as a representative name. Any device name may be used arbitrarily.

FIG. 6 is a diagram showing a cross reference information file issued by filing unit 5 (FIG. 1). In the column of “-Merge Device-” in FIG. 6, two device names (SMA, SMB) and representative name (SMA) of the logic circuit are shown. The subsequent process is same as the process in filling unit 5 (FIG. 1). That is, once the representative name is determined, the name is added to the device in the layout in a format of “representative name@xx”. Herein, “xx” is same as explained in filing unit 4 (FIG. 1), and M1, M2, etc. are given in the case of MOS device. In the examples in FIG. 5 and FIG. 6, “SMA@M1”, “SMA@M2”, “SMA@M3” are given. The column of “-Correspond-” in FIG. 6 shows that “SMA@M1” corresponds to “LM1” of the layout, “SMA@M2” to “LM2”, and “SMA@M3” to “LM3”. Further, in the intermediate wirings “LN_{—}1” and “LN_{—}2” in the layout, @1 and @2 are added to the intermediate wiring name “SNETA” so as to correspond from the output side. In this manner, filing unit 5 (FIG. 1) generates a correspondence table between the logic circuit and layout.

The cross reference information generated by filing unit 5 (FIG. 1) is stored in the cross reference information file 8 through the remaining filing units 6 and 7, and is used in the later process in net list generator 9 or analyzer 11. For example, in net list generator 9 or analyzer 11, suppose a wiring name of the layout corresponding to the wiring SNETA of the logic circuit shown in FIG. 5 is needed. Net list generator 9 refers to “Net name” after -“Correspond”- in the cross reference information file shown in FIG. 6, and specifies the wiring identified with SNETA. That is, it picks up the information that wiring SNETA of the logic circuit corresponds to two layout wirings “LN_{—}1” and “LN_{—}2”. Thus, wiring names “LN_{—}1” and “LN_{—}2” of the layout corresponding to the SNETA are obtained.

Referring now to FIG. 7 and FIG. 8, the operation of parallel-serial device cross reference information filing unit 6 (FIG. 1) is explained. Filing unit 6 operates when the cross reference information cannot be generated by either filing unit 4 or 5. FIG. 7 is a diagram showing an example of logic circuit and layout composed of plural devices by parallel connection and serial connection. The logic circuit includes three device names SMA, SMB and SMC, of which input is SA, SB and SC and output is OUT, and intermediate wirings SNETA and SNETB. LVS comparator 3 merges these three devices SMA, SMB and SMC at the time of LVS comparative verification in comparative verification unit 33 (FIG. 1), and handles the logic circuit net list as one function box enclosed by dotted line of which input is SA, SB and SC and output is OUT. Filing unit 6 (FIG. 1) receives the information of this box expressed as follows.

{INST SeriChain#2=N--3 {PIN GND=SD#0 OUT=SD#1 SC=G#0 SB=G#1 SC=G#2 GND=BULK}}

As the information expressing the function box, filing unit 6 (FIG. 1) also holds the following.

SeriChain#2{inst SMC=N} {inst SMB=N} {inst SMA=N}

As for the layout, similarly, LVS comparator 3 merges devices LM1 to LM6 at the time of LVS comparative verification by comparative verification unit 33 (FIG. 1), and handles the layout net list as one function box enclosed by dotted line of which input is LA, LB and LC and output is OUT. Filing unit 6 (FIG. 1) receives the information of this box expressed as follows.

{INST SeriChain#8=N--3 {PIN GND=SD#0 OUT=SD#1 LA=G#0 GND=BULK}}

As the information expressing the box enclosed by dotted line, filing unit 4 (FIG. 1) also holds the following.

SeriChain#21 {inst LM3=N {prop n=N, x=14.570, y=68.800}}

{inst LM2=N {prop n=N, x=13.870, y=68.800}}

[inst LM1=N {prop n=N, x=12.570, y=68.800}}

SeriChain#24 {inst LM6=N {prop n=N, x=14.770, y=58.800}}

{inst LM5=N {prop n=N, x=13.070, y=58.800}}

[inst LM4=N {prop n=N, x=12.070, y=58.800}}

Further, the series connection transistor group of LM1 to 3 and the parallel connection transistor group of LM4 to 6, by parallel connection, are merged into one, and the information expressing the box further includes the following.

ParaChain#37 {inst SeriChain#24=N--3 {prop}}

{inst SeriChain#21=N--3 {prop}}

When comparative verification unit 33 compares and verifies by LVS, the layout net list expressed as follows is utilized, and filing unit 6 (FIG. 1) also holds this information.

{INST ParaChain#37=N||2

{PIN GND=SD#0 OUT=SD#1 LC=G#0 LB=G#1 LA=G#2 GND=BULK}}

Filing unit 6 (FIG. 1) processes as follows based on the information identifying each box mentioned above. That is, by comparison of peripheral connection relation, input SA of the logic circuit net is judged to correspond to input LA of the layout, SB to LB, and SC to LC. At this time, SeriChain#2 of the logic circuit and ParaChain#37 of the layout are matched in all pins, and hence it is judged as SeriChain#2==ParaChain#37 (coincidence). At this point, the following four pieces of information are obtained, that is, SeriChain#2==ParaChain#37, and SA==LA, SB==LB, SC==LC.

Filing unit 6 (FIG. 1) takes notice of the first device as seen from output OUT, having the gate wiring name of SA/LA, in each one of the logic circuit net list and layout, based on the above information and each net list. As a result, filing unit 6 (FIG. 1) judges that only the SMA corresponds in the logic circuit, and two correspond in the layout, that is, LM1 and LM4. Similarly, filing unit 6 (FIG. 1) sequentially takes notice of the second device and third device as seen from output OUT, having the gate wiring name of SB/LB. As a result, it is judged that LM2 and LM5 of the layout correspond to SMB of the logic circuit device, and LM3 and LM6 of the layout to SMC of the logic circuit device. Filing unit 6 (FIG. 1) issues these results to the cross reference information file.

FIG. 8 is a diagram showing a cross reference information file issued by filing unit 6 (FIG. 1). In “LM1” and “LM4” of the layout, “SMA@M1” and “SMA@M2” correspond. In “LM2” and “LM5” of the layout, “SMB@M1” and “SMB@M2” correspond, and in “LM3” and “LM6” of the layout, “SMC@M1” and “SMC@M2” correspond. The cross reference information file also shows the corresponding relation of the intermediate wiring of the logic circuit and intermediate wiring of the layout. That is, the wiring “SNETA” of the logic circuit closer to output OUT corresponds to wirings “LN_{—}1” and “LN_{—}3” of the layout closer to output OUT side. Hence, in “LN_{—}1” and “LN_{—}3”, “SNETA@1” and “SNETA@2” correspond. Similarly, the wiring “SNETB” of the logic circuit corresponds to wiring “LN_{—}2” and “LN_{—}4” of the layout. Therefore, in “LN_{—}2” and “LA_{—}4′, “SNETB@1” and “SNETB@2” correspond. Thus, filing unit 6 (FIG. 1) generates a correspondence table between the logic circuit and layout.

The cross reference information generated by filing unit 6 (FIG. 1) is stored in cross reference information file 8 through the remaining filing unit 7, and is used in the later process in net list generator 9 or analyzer 11. For example, in net list generator 9 or analyzer 11, suppose a wiring name of the layout corresponding to the wiring “SNETA” of the logic circuit shown in FIG. 7 is needed. Net list generator 9 refers to “Net name” after -“Correspond”- in the cross reference information file shown in FIG. 8, and specifies the wiring identified with “SNETA”. That is, it picks up the information that wiring “SNETA” of the logic circuit corresponds to two layout wirings “LN_{—}1” and “LN_{—}3”. Thus, wiring names “LN_{—}1” and “LN_{—}3” of the layout corresponding to the “SNETA” are obtained.

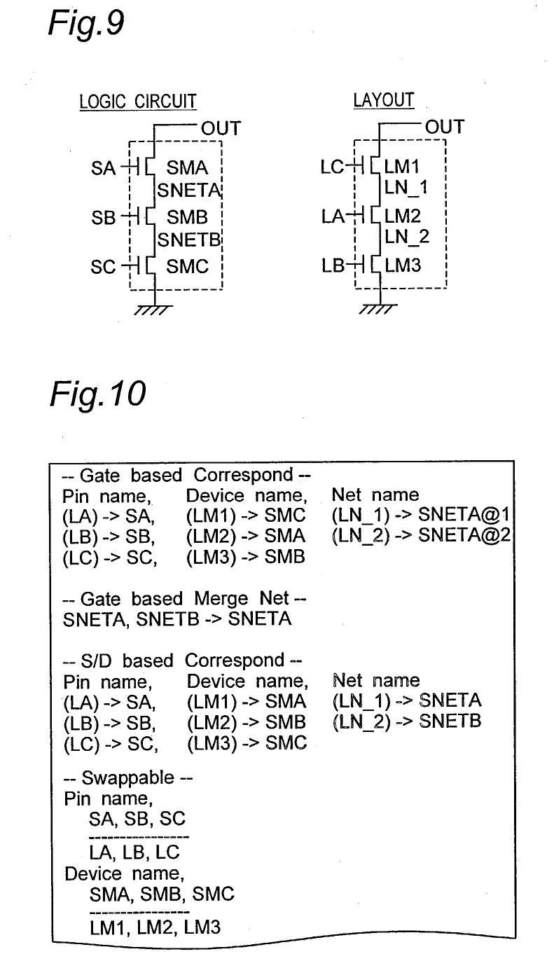

Referring now to FIG. 9 and FIG. 10, the operation of logically equivalent device cross reference information filing unit 7 (FIG. 1) is explained.

FIG. 9 is a diagram showing an example of logic circuit and layout composed of plural devices by serial connection. The inputs of the logic circuit are SA, SB, SC from the side closer to output OUT, and the inputs of the layout are LC, LA, LB from the side closer to output OUT. Hence, the same symbols (A, B, C) do not correspond to each other, such as SA and LA, SB and LB, or SC and LC.

First of all, when such logic circuit and layout are entered, LVS comparator 3 merges three devices SMA, SMB, SMC of the logic circuit at the time of LVS comparative verification in comparative verification unit 33 (FIG. 1), and handles the logic circuit net list as one function box enclosed by dotted line of which input is SA, SB, SC and output is OUT. At this time, LVS comparator 3 judges that the arraying sequence of inputs SA, SB, SC is not related to the logic. The reason is, as shown in Table 1 below, that output OUT is the grounding potential (GND) when all of SA, SB, and SC are 1, and is a constant value (1.8 V) in other cases regardless of the values of SA, SB, SC.

TABLE 1
Initial value of OUT: 1.8 V

| SA | SB | SC | OUT |
|---|---|---|---|
| 0 | 0 | 0 | 1.8 V |
| 0 | 0 | 1 | 1.8 V |
| 0 | 1 | 0 | 1.8 V |
| 0 | 1 | 1 | 1.8 V |
| 1 | 0 | 0 | 1.8 V |
| 1 | 0 | 1 | 1.8 V |
| 1 | 1 | 0 | 1.8 V |
| 1 | 1 | 1 | GND |

As a result, the logic circuit net list is expressed as follows, and filing unit 7 (FIG. 1) receives this information.

{INST SeriChain#4=N--3

{PIN GND=SD#0 OUT=SD#1 SC=G#s0 SB=G#s1 SC=G#s2 GND=BULK}}

Herein, the lower case “s” in “SC=G#s0”, “SC=G#s1”, “SC=G#s2” shows that they are mutually swappable. More specifically, SC is the first gate as seen from the GND, but it can be swapped with “SB” corresponding to “G#s1” or “SA” corresponding to “G#s2”. As the information expressing the function box enclosed by dotted line, filing unit 7 (FIG. 1) also holds the following.

SeriChain#4 {inst SMC=N}{inst SMB=N}{inst SMA=N}

In the layout, by the same reason as in the logic circuit, the arraying sequence of inputs LA, LB, LC is not related to the logic. Hence, the layout net list is expressed as follows, and filing unit 7 (FIG. 1) receives this information.

{INST SeriChain#14=N--3

{PIN GND=SD#0 OUT=SD#1 LB=G#s0 LA=G#s1 LC=G#s2 GND=BULK}}

As the information expressing the function box enclosed by dotted line, filing unit 7 (FIG. 1) also holds the following.

SeriChain#14 {inst LM3=N {prop n=N, x=71.900, y=21.200}}

{inst LM2=N (prop n=N, x=69.700, y=21.200}}

{inst LM1=N {prop n=N, x=67.500, y=21.200}}

Filing unit 7 (FIG. 1) processes as follows based on the information identifying each box mentioned above. That is, by comparison of peripheral connection relation, input SA of the logic circuit net is judged to correspond to input LA of the layout, SB to LB, and SC to LC. At this time, SeriChain#4 of the logic circuit and SeriChain#14 of the layout are matched in all pins, and hence it is judged as SeriChain#4==SeriChain#14 (coincidence). At this point, the following four pieces of information are obtained, that is, SeriChain#4==SeriChain#14, and SA==LA, SB==LB, SC==LC.

Filing unit 7 (FIG. 1) generates the cross reference information describing the corresponding relation of the logic circuit net list and layout based on the above information and each net list.

Filing unit 7 (FIG. 1) generates the cross reference information based on two kinds of standard. That is, the standard by connection position of the gate terminal, and the standard by connection position of the source terminal or drain terminal.

When based on the standard by connection position of the gate terminal, filing unit 7 (FIG. 1) defines gate “LC” of layout device “LM1” in FIG. 9 to correspond to gate “SC” of the logic circuit. Similarly, gate “LA” of the layout corresponds to gate SA of the logic circuit, and gate “LB” of the layout to gate “SB” of the logic circuit. FIG. 10 is a diagram showing a cross reference information file issued by filing unit 7 (FIG. 1). The cross reference information obtained by using the standard by connection position of the gate terminal is shown in “-Gate based Correspond-”. According to this standard, “LM1”, “LM2”, “LM3” of the layout correspond respectively to “SMC”, “SMA”, “SMB” of the logic circuit. Intermediate wirings “LN_{—}1”, “LN_{—}2” of the layout correspond to “SNETA”, “SNETB “of the logic circuit.

Referring back to FIG. 9, when based on the standard by connection position of source/drain terminal, since the drain wiring of layout device “LM1” is OUT, filing unit 7 (FIG. 1) defines “SMA” of which drain wiring is “OUT” to correspond to “LM1” of the layout. Similarly, “LM3” of the layout corresponds to “SMC” of the logic circuit, and “LM2” of the layout to “SMB” of the logic circuit. As a result, in FIG. 10, this corresponding relation is shown after “-S/D based Correspond-”. According to this standard, “LA”, “LB”, “LC” of the layout correspond respectively to “SA”, “SB”, “SC” of the logic circuit. Intermediate wirings “LN_{—}1”, “LN_{—}2” of the layout correspond to “SNETA”, “SNETB” of the logic circuit. Intermediate wirings “LN_{—}1”, “LN_{—}2” of the layout correspond to “SNETA”, “SNETB” of the logic circuit. Filing unit 7 (FIG. 1) extracts the information of device and wiring showing that the logic is the same if swapped, that is, the terminal and device provided with the lower case of “s” such as” SC=G#s0” or “SC=G#s1” as mentioned above, and adds after “Swappable”.

The cross reference information generated by filing unit 7 (FIG. 1) is stored in cross reference information file 8, and is used in the later process in net list generator 9 or analyzer 11. For example, in net list generator 9 or analyzer 11, suppose a device name of the layout corresponding to device “SMB” of the logic circuit shown in FIG. 9 is needed. Net list generator 9 refers to “Device name” after -“Gate based Correspond”- in the cross reference information file shown in FIG. 10, and specifies “LM3”. When desired to obtain a device name of the layout based on the standard by connection position of source/drain terminal, net list generator 9 specifies “LM2” from “S/D based Correspond”- in the cross reference information file shown in FIG. 10. Thus, the device name of the layout corresponding to each device of the logic circuit is obtained.

As explained herein, the cross reference information generated by filing units 4 to 7 can specify the correspondence between the logic circuit and layout in all elements including elements and intermediate wirings in the block. Net list generator 9 and analyzer 11 can analyze more specifically by referring to such cross reference information at the time of back annotation for verifying and analyzing the operation of the logic circuit in consideration of the element information parasitizing the layout, and only the specified path can be analyzed. That is, net list generator 9 and analyzer 11 can easily recognize the correspondence of the wiring name and device name of the logic circuit and layout, and the wiring name and device name can be specified by the name on the logic circuit diagram. Therefore, the recognition efficiency of corresponding relation is enhanced, and recognition errors can be curtailed.

The sequence of filing units 4 and 5 (FIG. 1) are swappable. Filing unit 6 is responsible for receiving the data of the of the logic circuit and layout if failing to process in both filing units 4 and 5.

(Embodiment 2)

In embodiment 2, a design verification apparatus adding further elements to the design verification apparatus in embodiment 1 is explained.

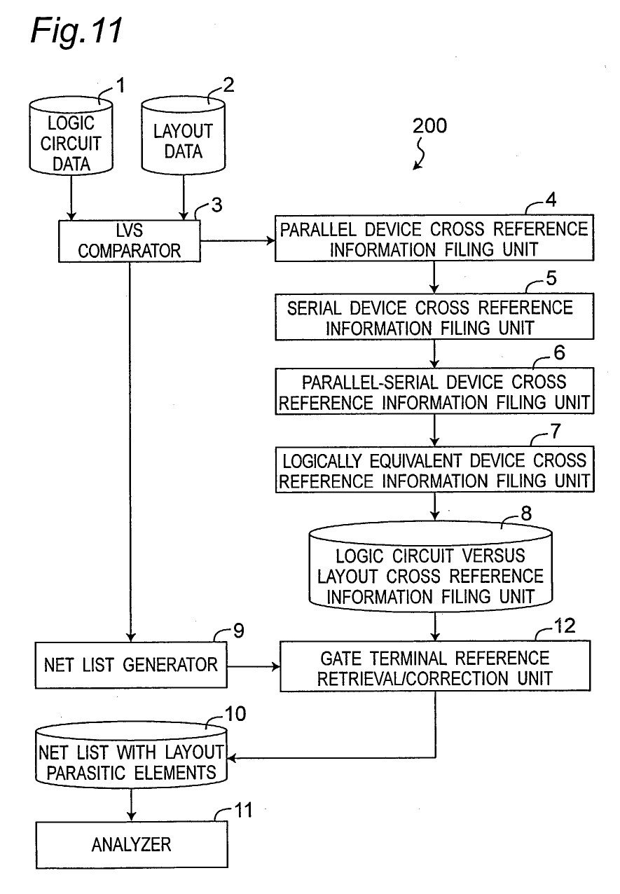

FIG. 11 is a block diagram showing a configuration of design verification apparatus 200 in embodiment 2. Design verification apparatus 200 includes gate terminal reference retrieval/correction unit 12 in addition to the configuration of design verification apparatus 100 (FIG. 1). In this embodiment, only gate terminal reference retrieval/correction unit 12 and related elements are explained. The function and operation of elements not relating directly are same as in the elements of design verification apparatus 100 (FIG. 1) in embodiment 1, and their explanation is omitted. In FIG. 11, the elements included in LVS comparator 3 are not described, but they are same as those indicated in LVS comparator 3 in the FIG. 1.

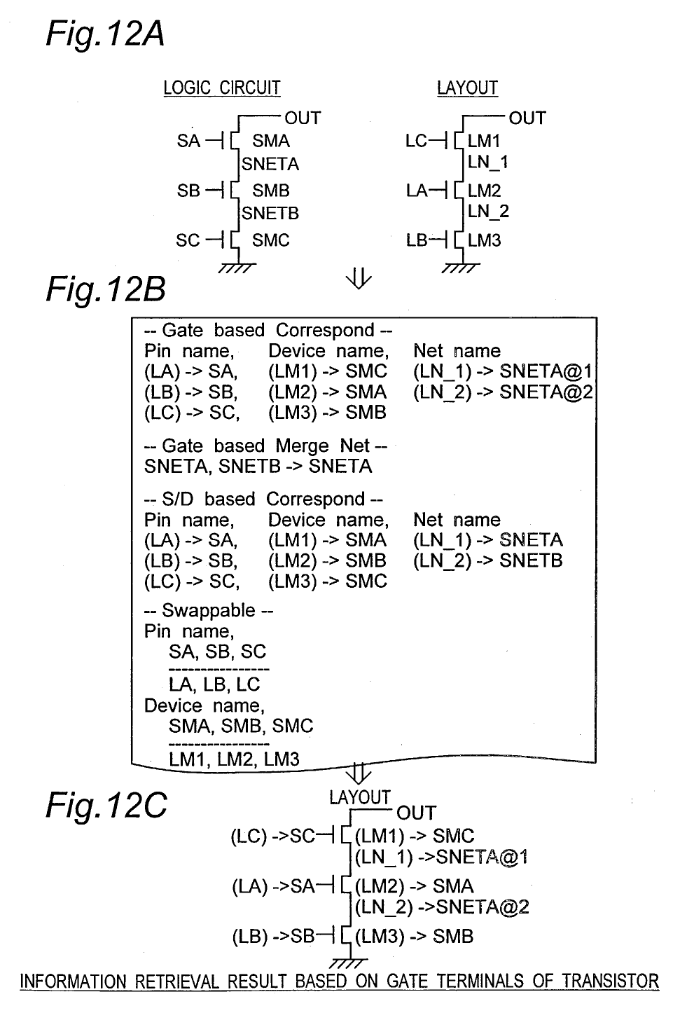

Gate terminal reference retrieval/correction unit 12 receives cross reference information file 8, and retrieves and corrects the corresponding information of logic circuit and layout based on the connection relation of gate terminals of transistors. It is specifically described below while referring to FIG. 12A to FIG. 12C.

FIG. 12A is a diagram showing logic circuit and layout. FIG. 12B is a diagram showing a cross reference information file generated by logically equivalent device cross reference information filing unit 7 (FIG. 11) from the logic circuit and layout in FIG. 12A. Gate terminal reference retrieval/correction unit 12 (FIG. 11) receives the cross reference information file, and retrieves the correspondence table described after -Gate based Correspond- included therein. Gate terminal reference retrieval/correction unit 12 also receives a net list with layout parasitic elements from net list generator 9. based on the result of retrieval, gate terminal reference retrieval/correction unit 12 corrects the received net list with layout parasitic elements, and arranges device names in the sequence of SMB, SMA, SMC from GND side, arranges gate wiring names in the sequence of SB, SA, SC, and arranges intermediate wiring names in the sequence of SNETA@2, SNETA@1.

Further, for example, when intermediate wiring “SNETA” in the logic circuit is extraction and output designation wiring relating to a parasitic element, gate terminal reference retrieval/correction unit 12 further retrieves a correspondence table described after -“Gate based Correspond”- in the cross link reference file. Layout parasitic element information is further extracted about layout wirings “LN_{—}1”, “LN_{—}2” corresponding to “SNETA”. The parasitic element information is added to the net list with layout parasitic elements. FIG. 12C shows information retrieval results based on gate terminals of transistors.

Thus, according to the embodiment, based on the connection relation of gate terminals of transistors, back annotation corresponding to the logic circuit automatically and completely is realized.

(Embodiment 3)

Embodiment 3 is a modified example of embodiment 2. That is, embodiment 3 relates to a design verification apparatus having source/drain terminal reference retrieval/correction unit 13, instead of gate terminal reference retrieval/correction unit 12 (FIG. 11) explained in embodiment 2.

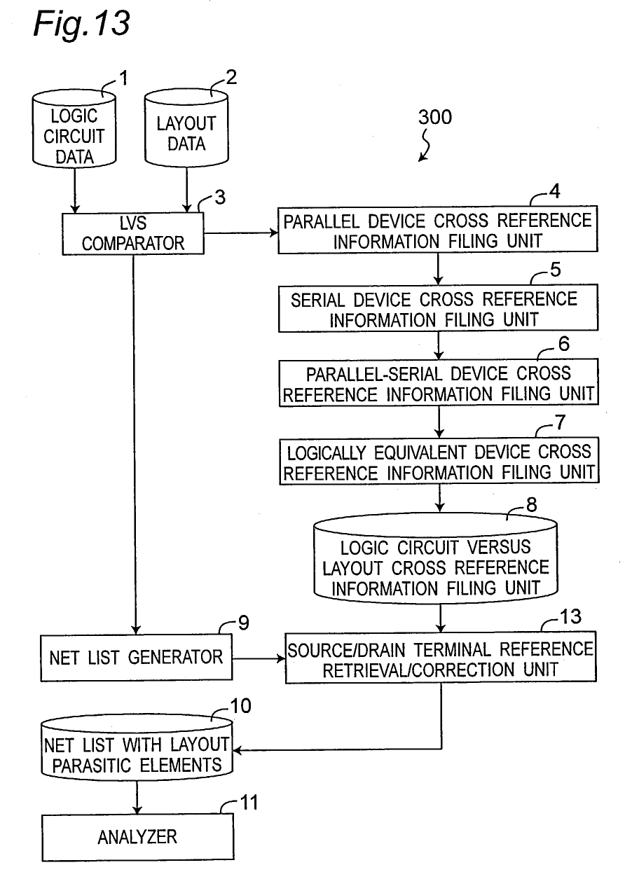

FIG. 13 is a block diagram showing a configuration of design verification apparatus 300 in embodiment 3. Design verification apparatus 300 includes source/drain terminal reference retrieval/correction unit 13 instead of gate terminal reference retrieval/correction unit 12 of design verification apparatus 200 (FIG. 11). In this embodiment, only source/drain terminal reference retrieval/correction unit 13 and related elements are explained. Explanation of other elements in embodiments 1 and 2 is omitted.

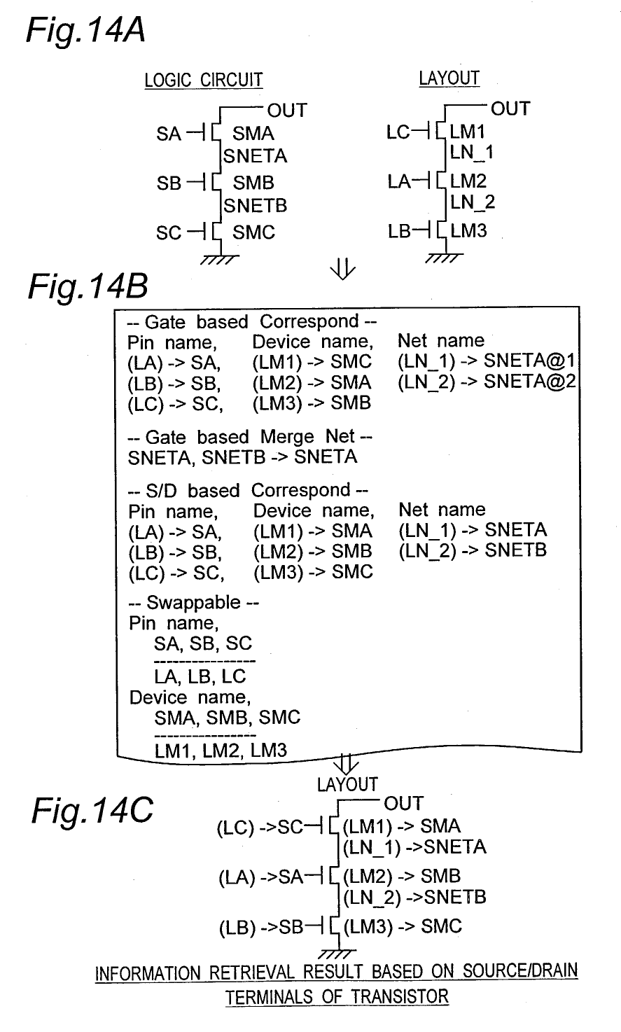

Source/drain terminal reference retrieval/correction unit 13 receives cross reference information file 8, and retrieves and corrects the corresponding relation of logic circuit and layout based on the connection relation of source and drain terminals of transistor. This is more specifically explained below by referring to FIGS. 14A to 14C.

FIG. 14A is a diagram showing the logic circuit and layout. FIG. 14B is a diagram showing the cross reference information file created from the logic circuit and layout in FIG. 14A by logically equivalent device cross reference information filing unit 7 (FIG. 11). Source/drain terminal reference retrieval/correction unit 13 (FIG. 13) receives the cross reference information file, and retrieves the correspondence table described after -“S/D Based Correspond”- included therein. Source/drain terminal reference retrieval/correction unit 13 further receives a net list with layout parasitic elements from net list generator 9. based on the result of retrieval, source/drain terminal reference retrieval/correction unit 13 corrects the received net list with layout parasitic elements, and arranges device names in the sequence of SMC, SMB, SMA from GND side, arranges gate wiring names in the sequence of SB, SA, SC, and arranges intermediate wiring names in the sequence of SNETB, SNETA.

Further, for example, when intermediate wiring SNETA in the logic circuit is an extraction and output designation wiring relating to the parasitic element, source/drain terminal reference retrieval/correction unit 13 further retrieves the correspondence table described after -“SID Based Correspond”- in the cross reference information file. As for layout wirings “LN_{—}1”, “LN_{—}2” corresponding to “SNETA”, layout parasitic element information is extracted. This parasitic element information is added to the net list with layout parasitic elements.

Thus, according to this embodiment, based on the connection relation of source and drain terminals of transistors, back annotation automatically and completely corresponding to the logic circuit is realized. FIG. 14C shows the information retrieval result based on the source and drain terminals of transistors.

It is also possible to devise a design verification apparatus including both gate terminal reference retrieval/correction unit 12 (FIG. 11) explained in embodiment 2 and source/drain terminal reference retrieval/correction unit 13 explained in embodiment 3. The user can determine, as required, the back annotation based on the connection relation of either gate terminal or source and drain terminals.

(Embodiment 4)

Embodiment 4 relates to a semiconductor design verification apparatus for pre-layout simulation before completion of layout design. “The pre-layout simulation” is an operation verification of logic circuit not considering the parasitic element information extracted from the layout, by using a logic circuit net list. This is more specifically explained below.

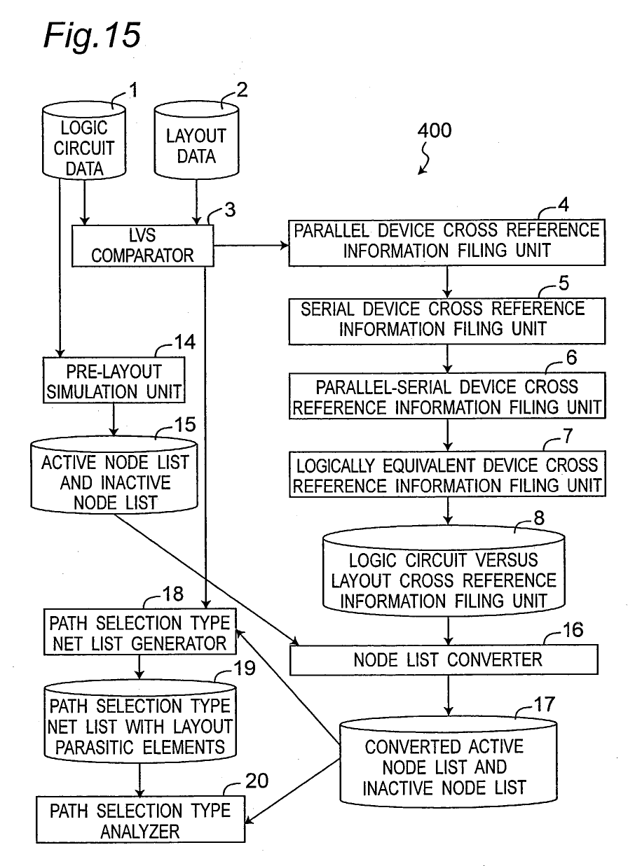

FIG. 15 is a block diagram showing a configuration of design verification apparatus 400 in embodiment 4. Design verification apparatus 400 includes logic circuit data 1, layout data 2, LVS comparator 3, cross reference information filing units 4 to 7 of parallel device, serial device, parallel-serial device, and logically equivalent circuit device, and cross reference information file 8 relating to logic circuit versus layout. The function and operation of these elements are same as those identified with same reference numerals of design verification apparatus 100 (FIG. 1) of embodiment 1, and their explanation is omitted.

Design verification apparatus 400 further includes pre-layout simulation unit 14, node list 15, node list converter 16, converted node list 17, path selection type net list generator 18, path selection type net list 19, and pass selection type analyzer 20.

Their function and operation are explained below. First of all, pre-layout simulation unit 14 executes an operation verification of the circuit by using logic circuit data 1. Herein, the pre-layout simulation is a simulation about changes of potential of nodes when a specified voltage is applied to the logic circuit. Node list 15 describes the result of simulation by pre-layout simulation unit 14, that is, a node list showing presence or absence of potential change of each node. More specifically, node list 15 is composed of active node list and inactive node list. The active node list describes the name of the node changed in potential at the time of pre-layout simulation. The inactive node list describes the potential and the name of the node not changed in potential at the time of pre-layout simulation. Node list 15 is also stored in a storage device as specified database. This storage device is same as the storage device storing logic circuit data 1 and layout data 2.

Node list converter 16 adds all node names and potentials at the layout side corresponding to the described node names to each list, relating to the inactive node list of node list 15, based on cross reference information file 8. Converted node list 17 includes converted active node list and converted inactive node list issued from node list converter 16.

Path selection type net list generator 18 extracts only the parasitic element information of the layout corresponding to a partial circuit operating at the time of simulation by using the comparison result issued from LVS comparator 3 and converted node list 17. Further, generator 18 generates a layout net list by adding only the parasitic element information of the corresponding layout, only in the partial circuit necessary for layout. This layout net list is called path selection type net list with parasitic elements 19. Path selection type analyzer 20 verifies and analyzes the operation of the logic circuit based on the inactive node list of converted node list 17 and path selection type net list 19.

Thus, by the pre-layout simulation, the information of nodes changed in potential and the information of nodes not changed in potential are obtained, and the path selection type net list generator refers to the information, and therefore the semiconductor design verification apparatus can take into consideration only the information of the layout parasitic elements corresponding to the partial circuit operating at the time of simulation.

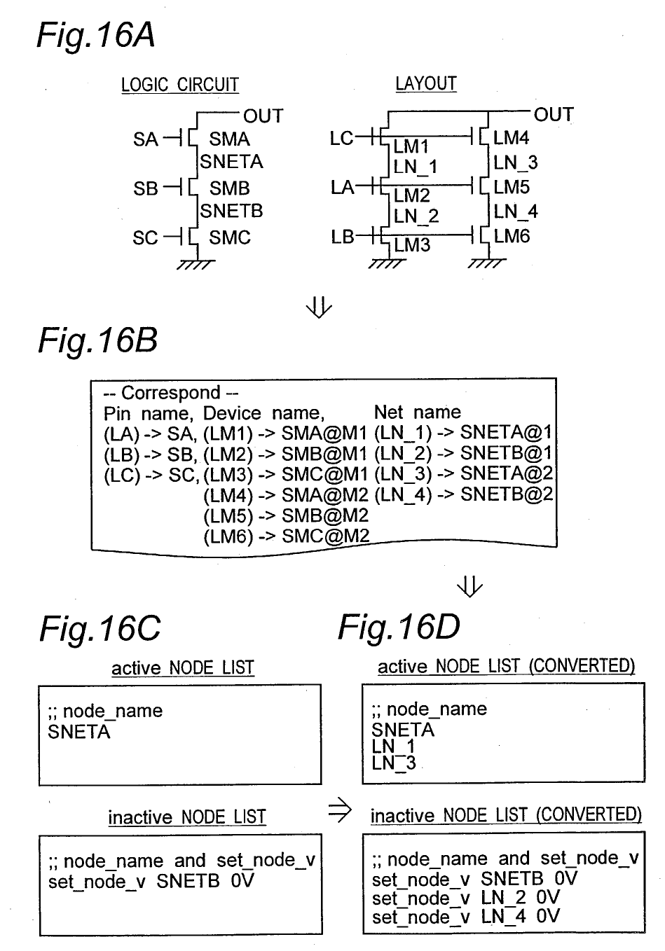

Referring next to FIGS. 16A to 16D, principal operations of design verification apparatus 400 are explained. FIG. 16A is a diagram showing the logic circuit and layout. As clear from the diagram, plural devices are connected in parallel and in series. FIG. 16B shows a cross reference information file generated by parallel-serial device cross reference information filing unit 6 (FIG. 15) based on the logic circuit and layout in FIG. 16A. That is, suppose cross reference information file 8 (FIG. 15) has been already generated. FIG. 16C shows an example of active node list and inactive node list. FIG. 16D shows an example of converted active node list and converted inactive node list.

Node list converter 16 searches for presence or absence of wiring name “SNETA” described in the active node list (FIG. 16C) in the cross reference information file (FIG. 16B). When it is known that wiring name “SNETA” exists, node list converter 16 adds the corresponding layout wiring names “LN_{—}1” and “LN_{—}3” and issues to the existing active node list. This output result is the converted active node list (FIG. 16D).

Next, node list converter 16 searches for presence or absence of wiring name SNETB described in the inactive node list (FIG. 16C) in the cross reference information file (FIG. 16B). When it is known that wiring name “SNETB” exists, node list converter 16 adds the corresponding layout wiring names “LN_{—}2” and “LN_{—}4” and issues to the existing inactive node list. In the inactive node list, the constant potential definition of “SNETB” is 0 V. The constant potential definition of the additionally issued layout wiring names “LN_{—}2” and “LN_{—}4” is set at 0 V same as in “SNETB”.

Path selection type net list generator 18 refers to the converted active node list (FIG. 16D), extracts parasitic element information of the layout about wiring names “SNETA”, “LN_{—}1”, “LN_{—}3”, and issues a net list with layout parasitic element information about wiring names “SNETA”, “LN_{—}1”, “LN_{—}3”. Path selection type analyzer 20 (FIG. 15) refers to the converted inactive node list (FIG. 16D), and sets the potential of wiring names “SNETB”, “LN_{—}2”, “LN_{—}4” to 0 V. In a conventional apparatus, neither active node nor inactive node, but nodes not specified in potential existed in layout intermediate nodes of parallel and serial composite merge device group, but the design verification apparatus of the invention realizes path selection type back annotation specifying the active nodes and inactive nodes automatically and completely.

(Embodiment 5)

Embodiment 5 relates to a semiconductor design verification apparatus for generating a net list with layout parasitic element information of logic circuit base.

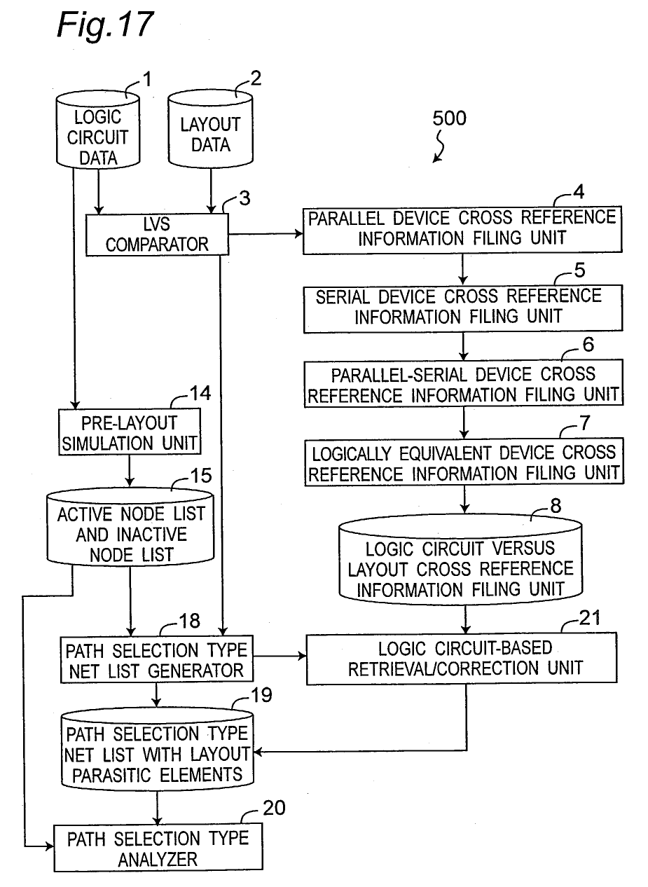

FIG. 17 is a block diagram showing a configuration of design verification apparatus 500 in embodiment 5. Design verification apparatus 500 includes logic circuit data 1, layout data 2, LVS comparator 3, cross reference information filing units 4 to 7 of parallel device, serial device, parallel-serial device, and logically equivalent circuit device, cross reference information file 8 relating to logic circuit versus layout, pre-layout simulation unit 14, node list 15, and pass selection type analyzer 20. The function and operation of these elements are same as those identified with same reference numerals of the design verification apparatus of embodiments 1 and 4, and their explanation is omitted.

Design verification apparatus 500 further includes path selection type net list generator 18, path selection type analyzer 20, logic circuit reference retrieval/correction unit 21, and path selection type net list 22 of logic circuit base. Path selection type net list generator 18 extracts only the parasitic element information of the layout corresponding to a partial circuit operating at the time of simulation, by using the comparison result issued from LVS comparator 3 and node list 15. Logic circuit reference retrieval/correction unit 21 retrieves and corrects the corresponding information of logic circuit and layout based on the logic circuit, from cross reference information file 8, based on the output of path selection type net list generator 18. Path selection type net list 22 generates a net list including the parasitic element information of the layout corresponding to the partial circuit operating at the time of simulation generated in reference retrieval/connection unit 21. This is a net list with path selection type parasitic elements of logic circuit base, completely matched in the connection relation of logic circuits and number of devices, and device and wiring names. The path selection type analyzer 20 verifies and analyzes the operation of the logic circuit based on the path selection type net list 22 and node list 15.

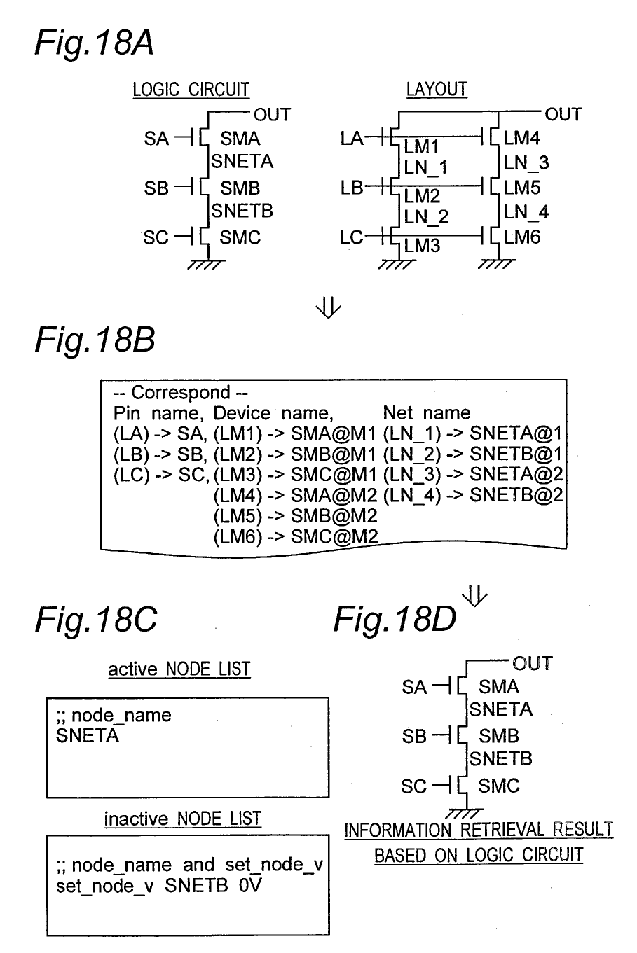

Referring next to FIG. 18A to FIG. 18D, principal operations of design verification apparatus 500 are explained. In FIG. 18A to FIG. 18C, plural devices are connected in parallel and in series, and same examples as in FIG. 16A to FIG. 16C are used. When the logic circuit and layout shown in FIG. 18A are given, parallel-serial device cross reference information filing unit 6 (FIG. 17) generates a cross reference information shown file in FIG. 18B. On the other hand, pre-layout simulation unit 14 generates node list 15 shown in FIG. 16C.

FIG. 18D shows the retrieval result based on the logic circuit. This retrieval is conducted as follows. Path selection type net list generator 18 extracts layout parasitic element information about wiring name “SNETA” described in active node list 15, and generates a net list with layout parasitic element information about wiring name “SNETA”. Next, logic circuit reference retrieval/correction unit 21 refers to the corresponding table described after ”--Correspond--” in cross reference information file (b), returns the information about layout devices “LM1” and “LM4” to logic circuit device “SMA”, and similarly returns the information about layout devices “LM2” and “LM5” to logic circuit device “SMB”, and also returns the information about layout devices “LM3” and “LM6” to logic circuit device “SMC”.

On the other hand, concerning the layout wiring, parasitic information is also extracted about wiring names “LN_{—}1” and “LN_{—}3”. This is because wiring “SNETA” as the object of parasitic element extraction corresponds to “LN_{—}1” and “LN_{—}3”. Hence, the information about “LN_{—}1” and “LN_{—}3” is returned to logic circuit wiring “SNETA”. By contrast, logic circuit wiring “SNETB” corresponding to “LN_{—}2” and “LN_{—}4” is not the wiring as the object of parasitic element extraction, parasitic information is not extracted about layout wiring names “LN_{—}2” and “LN_{—}4”, but is returned to logic circuit wiring “SNETB”, thereby generating a net list of logic circuit base with layout parasitic element information.

Thus, according to the embodiment, using the net list with layout parasitic element information of logic circuit base, the active node list and inactive node list issued by pre-layout simulation are used directly, and the path selection type back annotation is realized.

(Embodiment 6)

Embodiment 6 relates to a semiconductor design verification apparatus combining a logic circuit net list and a net list with power supply/GND layout parasitic element information, about power supply/GND line analysis back annotation.

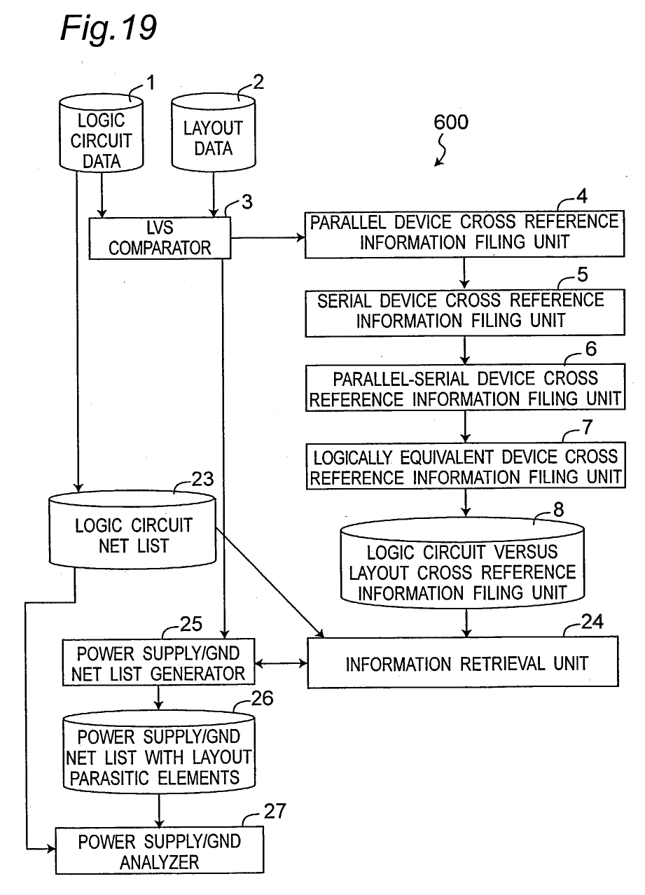

FIG. 19 is a block diagram showing a configuration of design verification apparatus 600 in embodiment 6. Design verification apparatus 600 includes logic circuit data 1, layout data 2, LVS comparator 3, cross reference information filing units 4 to 7 of parallel device, serial device, parallel-serial device, and logically equivalent circuit device, and cross reference information file 8 relating to logic circuit versus layout. The function and operation of these elements are same as those identified with same reference numerals of the design verification apparatus of embodiment 1, and their explanation is omitted.

Design verification apparatus 600 further includes logic circuit net list 23, information retrieval unit 24, power supply/GND net list generator 25, net list with power supply/GND layout parasitic elements 26, and power supply/GND analyzer 27. Logic circuit net list 23 is data extracted from logic circuit data 1. In the foregoing explanation, logic circuit data 1 is explained by referring to logic circuit net list, and it is not particularly different also in this embodiment. In this embodiment, however, in the sense of clarifying the positive use of logic circuit net list, logic circuit net list 23 is described. Information retrieval unit 24, using cross reference information file 8, combines the net list with parasitic element information of power supply/GND line, and logic circuit net list as internal circuit information, and retrieves the corresponding information of logic circuit and layout. Power supply/GND net list generator 25 extracts the parasitic element information of the power supply/GND line based on the LVS comparison result issued from LVS comparator 3 and retrieval result of information retrieval unit 24, and generates net list with power supply/GND line parasitic element information 26. Power supply/GND analyzer 27 combines logic circuit net list 23 as internal circuit information and net list 26, and verifies and analyzes the operation of the logic circuit.

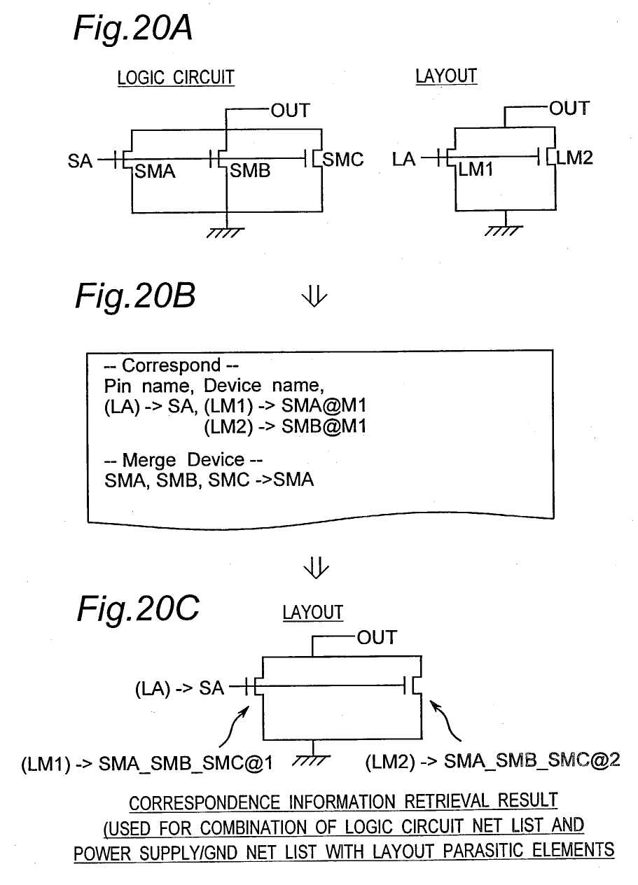

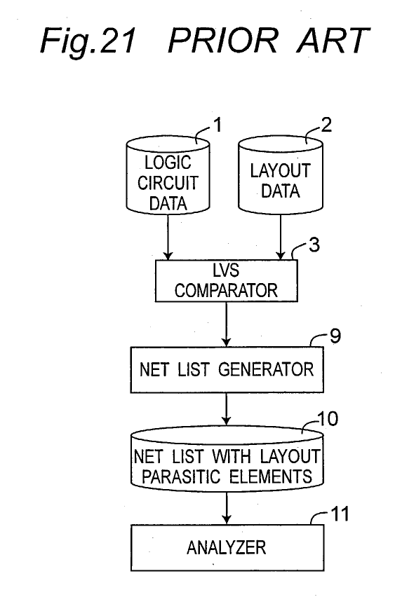

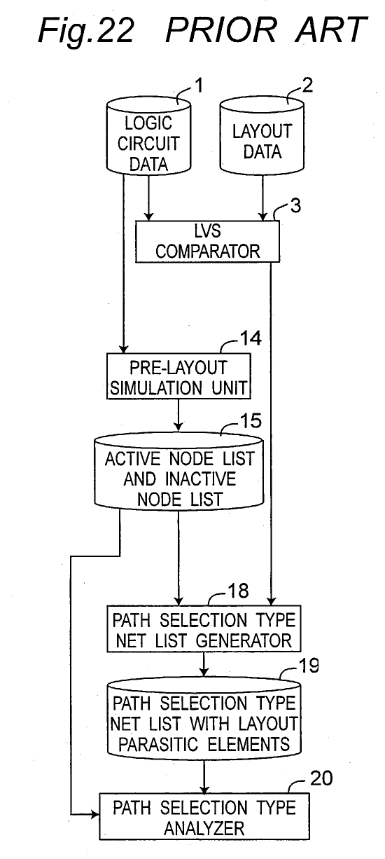

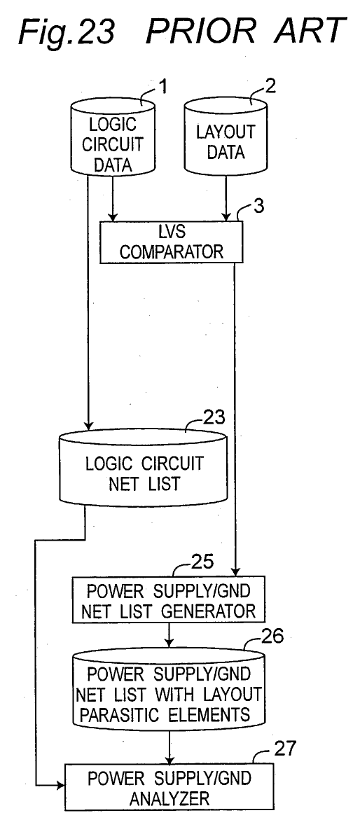

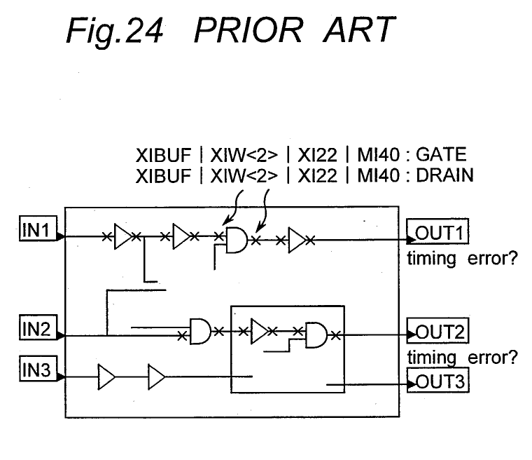

Further, referring to FIG. 20A to FIG. 20C, principal operations of design verification apparatus 600 are explained. FIG. 20A is a diagram showing the logic circuit and layout. In the diagram, it is understood that plural devices are connected in parallel. FIG. 20B is a cross reference information file generated by parallel device cross reference information filing unit 4 (FIG. 19) based on the logic circuit and layout in FIG. 20A. FIG. 20C is a diagram showing retrieval results by information retrieval unit 24 (FIG. 19).

Information retrieval unit 24 retrieves cross reference information file (b), and recognizes from the content of “--Correspond--” that layout device “LM1” corresponds to “SMA@1”, and from the content of “--Merge Device--” that three devices “SMA”, “SMB”, “SMC” of the logic circuit are merged to have a representative name of “SMA”. As a result, information retrieval unit 24 assigns layout device “LM1” with a name of “SMA_SMB_SMC@1”. Similarly, “LM2” is assigned with a name of “SMA_SMB_SMC@2”. Power supply/GND net list generator 25 issues net list with power supply/GND layout parasitic elements 26 to layout device LM1 by the device name of “SMA_SMAB_SMC@1”, and to layout device LM2 by the device name of “SMA_SMB_SMC@2”.

In succession, power supply/GND analyzer 27 (FIG. 19) confirms that the three parallel devices of the logic circuit correspond to the two parallel devices of the layout, based on device names “SMA_SMB_SMC@1” and “SMA_SMB_SMC@2” included in net list with power supply/GND layout parasitic elements 26. Power supply/GND analyzer 27 distributes the sum of the power supplies fed from devices “SMA”, “SMB” and “SMC” of logic circuit net list 23 to two source terminals of net list with power supply/GND layout parasitic elements 26 (source terminals of “SMA_SMB SMC@1” and “SMA_SMB_SMC@2”).

In a conventional apparatus, if the number of elements differs between the logic circuit and layout, mismatching occurs in the linkage positions of the power supply/GND line and internal circuit, but according to the design verification apparatus of the invention, linkage positions of power supply/GND line and internal circuit are matched completely in any case, so that power supply/GND line back annotation of high precision is realized.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A design verification apparatus comprising:
a storage unit which stores logic circuit data on elements in a logic circuit and wiring among the elements, and layout data about layout pattern of the logic circuit;
an element recognition unit which recognizes a connection relation of the elements based on the layout data;
a comparative verification unit which compares and verifies a correspondence between the connection relation of the logic circuit based on the logic circuit data, and the connection relation of the layout recognized by the element recognition unit, said comparative verification unit merging a plurality of elements in the logic circuit as a first function unit based on the logic circuit data, merging the plurality of elements in the logic circuit as a second function unit based on the connection relation recognized by the element recognition unit, and comparing and verifying the correspondence of a first connection relation of a plurality of merged elements in the first function unit and a second connection relation of the plurality of merged elements in the second function unit; and
a cross reference information filing unit which, depending on the connection relation of the logic circuit, generates cross reference information specifying a corresponding relation of the plurality of elements in the first function unit and their wiring and the plurality of elements in the second function unit and their wiring.

2. The design verification apparatus according to claim 1, wherein the cross reference information filing unit generates cross reference information of the logic circuit with a parallel connection.

3. The design verification apparatus according to claim 1, wherein the cross reference information filing unit generates cross reference information of the logic circuit with a serial connection.

4. The design verification apparatus according to claim 3, wherein the cross reference information filing unit generates cross reference information of the logic circuit by coexistence of the parallel connection and the serial connection.

5. The design verification apparatus according to claim 4, wherein the comparative verification unit further judges whether the logic circuit is logically equivalent or not if the plurality of elements are swapped with each other, and if logically equivalent, the cross reference information filing unit generates cross reference information showing that the element group judged to be logically equivalent is swappable.

6. The design verification apparatus according to claim 5, further comprising a retrieval unit which retrieves the correspondence of elements or wiring of the logic circuit, and elements or wiring of the layout pattern, based on the cross reference information generated by the cross reference information filing unit,
wherein the retrieval unit retrieves the correspondence based on the connection relation of gate terminals of the transistors when the elements are transistors including gate terminal, source terminal and drain terminal.

7. The design verification apparatus according to claim 5, further comprising a retrieval unit which retrieves the correspondence of elements or wiring of the logic circuit and elements or wiring of the layout pattern, based on the cross reference information generated by the cross reference information filing unit,
wherein the retrieval unit retrieves the correspondence based on the connection relation of source terminal and drain terminal of the transistors when the elements are transistors including gate terminal, source terminal and drain terminal.

8. The design verification apparatus according to claim 5, further comprising:
a simulation unit which simulates potential changes of nodes when a specified voltage is applied to the logic circuit based on the logic circuit data stored in a storage unit, said simulation unit generating a first node list specifying nodes in the logic circuit not changed in potential obtained as a result of simulation; and
a node list converter which specifies nodes of the layout pattern corresponding to the nodes not changed in potential in the logic circuit based on the first node list generated by the simulation unit and the layout data stored in the storage unit, and converts the first node list into a second node list further including the specified nodes of the layout pattern.

9. The design verification apparatus according to claim 8,
wherein the simulation unit generates a third node list specifying the nodes of the logic circuit changed in potential obtained as a result of simulation, and
wherein the node list converter specifies nodes of the layout pattern corresponding to the nodes of the logic circuit changed in potential based on the third node list generated by the simulation unit and the layout data stored in the storage unit, and converts the third node list into a fourth node list by further adding the specified nodes of the layout pattern.

10. The design verification apparatus according to claim 9, further comprising a net list generator which generates a layout net list by adding the information about parasitic elements to the information of elements and wiring in the layout pattern, by extracting the information about parasitic elements of the layout pattern corresponding to a partial circuit as part of the logic circuit, based on the result of comparison and verification by the comparative verification unit and the fourth node list.

11. The design verification apparatus according to claim 5,
wherein the logic circuit data is a logic circuit net list describing the information about elements and wiring in the logic circuit, and
wherein the design verification apparatus further comprises:
a retrieval unit which retrieves the correspondence between the logic circuit and layout based on the cross reference information generated by the cross reference information filing unit and the logic circuit net list; and
a net list generator which generates a layout net list by adding information about parasitic elements to the information of elements and wiring in the layout pattern, by extracting the parasitic elements of the layout pattern corresponding to the wiring layout from the power supply to the ground based on the result of comparison and verification by the comparative verification unit.
